(19) United States
(12) Patent Application Publication
(10) Pub. No.: US 2026/0034541 A1
(43) Pub. Date: Feb. 5, 2026

(54) ION EXCHANGER FILTER ASSEMBLY AND CONNECTION PIPE

(71) Applicant: MANN+HUMMEL GmbH, Ludwigsburg (DE)

(72) Inventor: Andreas WILDERMUTH, Marbach am Neckar (DE)

(21) Appl. No.: 19/273,439

(22) Filed: Jul. 18, 2025

(30) Foreign Application Priority Data
Aug. 5, 2024 (DE) 202024104396.0

(51) Int. Cl. B01J 47/022; H01M 8/04044

(52) U.S. Cl. CPC B01J 47/022; H01M 8/04044

(57) ABSTRACT

An ion exchanger filter assembly to be flowed through by liquid to be filtered has at least two ion exchanger units, each provided with a housing with an inlet socket and an outlet socket. An inlet-side fluid connection and an outlet-side fluid connection connect the ion exchanger units to each other. The inlet sockets are connected in fluid communication to the inlet-side fluid connection and the outlet sockets to the outlet-side fluid connection. The ion exchanger units are arranged to provide parallel flow along a flow path. Each flow path has a section through the inlet-side fluid connection, a section through the ion exchanger unit, and a section through the outlet-side fluid connection for uniform flow therethrough. Either all flow paths have a same length or have a same flow resistance. A connection pipe for such a filter assembly.

### CROSS-REFERENCE TO RELATED APPLICATIONS

This application claims the benefit of German Application No. 202024104396.0 filed on Aug. 5, 2024, the entire contents of which is incorporated herein by reference.

### BACKGROUND

The invention concerns an ion exchanger filter assembly to be flowed through by a liquid to be filtered, for example for a fuel cell system, as well as a connection pipe for an ion exchanger filter assembly.

Fuel cells have an electrical efficiency of approximately 50%. The remainder of the energy is obtained as heat. The heat must be discharged in order to keep the efficiency of the fuel cell as high as possible. For this purpose, a cooling medium flows about the fuel cell. When the cooling medium is electrically conducting, short circuits may occur between the cells. Therefore, deionization by means of an ion exchanger is required. Because the cooling liquid must also fulfill further properties such as antifreeze properties, mixtures are used here, for example, deionized water and mono ethylene glycol in a ratio of 50:50.

### SUMMARY

It is an object of the invention to provide an easily mountable ion exchanger filter assembly to be flowed through by a liquid to be filtered, for example for a fuel cell system.

A further object of the invention is to provide an easily mountable connection pipe for such an ion exchanger filter assembly.

The aforementioned object is solved according to an aspect of the invention by an ion exchanger filter assembly to be flowed through by a liquid to be filtered, for example for a fuel cell system, including at least two ion exchanger units, which include identical housings each provided with an inlet socket and an outlet socket, and including an inlet-side fluid connection and an outlet-side fluid connection which connect the ion exchanger units in fluid communication to each other, wherein the inlet sockets of the at least two ion exchanger units are connected in fluid communication to the inlet-side fluid connection and the outlet sockets to the outlet-side fluid connection, wherein the ion exchanger units are arranged to be flowed through in parallel, wherein the flow paths each include a section through the inlet-side fluid connection, a section through the respective ion exchanger unit, and a section through the outlet-side fluid connection, wherein the flow paths each are designed to be flowed through uniformly, and wherein either all flow paths have the same length or wherein all flow paths have the same flow resistance.

The further object is solved according to a further aspect of the invention by a connection pipe for an ion exchanger filter assembly, including a length extension and including along the length extension at least two connection openings for providing a fluid connection to an inlet socket or an outlet socket of an ion exchanger unit.

Embodiments, features and advantages of the invention are made apparent from this description and the accompanying drawings.

According to an aspect of the invention, an ion exchanger filter assembly to be flowed through by a liquid to be filtered, for example for a fuel cell system, is proposed including at least two ion exchanger units, which include identical housings each provided with an inlet socket and an outlet socket, and including an inlet-side fluid connection and an outlet-side fluid connection which connect the ion exchanger units in fluid communication to each other. The inlet sockets of the at least two ion exchanger units are connected in fluid communication to the inlet-side fluid connection and the outlet sockets to the outlet-side fluid connection. The ion exchanger units are arranged to be flowed through in parallel, wherein flow paths each include a section through the inlet-side fluid connection, a section through the respective ion exchanger unit, and a section through the outlet-side fluid connection. In this context, the flow paths each are designed to be flowed through uniformly and either all flow paths have the same length or all flow paths have the same flow resistance.

Any number of ion exchanger units may be connected in fluid communication by the fluid connections to form an ion exchanger filter assembly, for example, for a fuel cell system. The entire ion exchanger filter assembly includes only one inlet connector and one outlet connector for connecting to a cooling circuit.

An advantage is that commercially available exchangeable ion exchanger cartridges may be employed. In addition, the individual cartridges may be filled with different resins, for example, one cartridge provided only with anion resin, the other cartridge provided only with cation resin. A ratio different than 50:50 may be realized easily, as needed.

The fluid connections are designed such that they ensure the full function of the combined individual ion exchanger units with respect to capacity and efficiency. For example, the fluid connections have the same geometry and length in order to ensure a uniform distribution of the volume flow of the liquid through the ion exchanger housings. The individual ion exchanger units may be flowed through uniformly in this context.

According to an embodiment of the ion exchanger filter assembly, the inlet-side fluid connection and the outlet-side fluid connection each may include at least one connection pipe which, along its length extension, includes at least one connection opening per ion exchanger unit, respectively. In this context, the inlet sockets of the ion exchanger units may be connected in fluid communication to the connection openings of the at least one connection pipe and the outlet sockets of the ion exchanger units may be connected in fluid communication to the connection openings of the at least one other connection pipe.

The connection openings of the connection pipes may be connected to the inlet sockets and outlet sockets of the housings of the ion exchanger units, wherein a connection pipe is provided at the inlet side of the ion exchanger units and a connection pipe at the outlet side of the ion exchanger units, respectively. The connections pipes themselves each have an inlet connector and an outlet connector with which they may be connected in a simple manner to the cooling circuit of the fuel cell system.

According to an embodiment of the ion exchanger filter assembly, the connection openings of the connection pipes may include radially inwardly arranged seal elements which are held by holding elements, for example plastic rings. In this context, the holding elements may be for example clipped into the connection openings or may be welded thereto. In this manner, the housings of the ion exchanger units may be connected reliably to the connection pipes.

According to an embodiment of the ion exchanger filter assembly, the inlet sockets and the outlet sockets of the housings may be held by means of clamping elements, for example spring elements, which engage circumferentially extending grooves of the inlet sockets and the outlet sockets through at least partially circumferentially extending slots of the connection openings. In this way, the connection between the connection pipe and the ion exchanger unit may be secured in a simple manner.

According to an embodiment of the ion exchanger filter assembly, the at least one inlet-side connection pipe and the at least one outlet-side connection pipe each may include a closed end and an outlet connector. As an alternative, at least two inlet-side connection pipes and/or at least two outlet-side connection pipes may be present which include an inlet connector and an outlet connector. As an alternative, at least two inlet-side connection pipes and/or at least two outlet-side connection pipes may be present and the outlet connector of one of the connection pipes is connectable in fluid communication to an inlet connector of an adjoining one of the connection pipes. The inlet-side fluid connection and the outlet-side fluid connection may thus be realized with one connection pipe, respectively, or, as an alternative, it is however also possible to realize the fluid connections with several connection pipes arranged sequentially and connected in fluid communication to each other.

According to an embodiment of the ion exchanger filter assembly, the housings of the ion exchanger units may be arranged by means of holders, for example holders extending circumferentially around the housings, on a common support plate. In this way, a compact ion exchanger filter assembly may be securely mounted.

According to an embodiment of the ion exchanger filter assembly, the support plate may be designed to provide a tolerance compensation for mounting of the housings. In this context, the support plate may for example include slotted holes for tolerance compensation for the attachment of the holders. In this way, the ion exchanger units may be connected seal-tightly in a simple manner to the connection pipes.

According to an embodiment of the ion exchanger filter assembly, the outlet connectors of the connection pipes may include radially outwardly arranged coupling sleeves for fixation to an external connection conduit. In this way, the entire ion exchanger filter assembly may be connected in a simple and reliable manner to a cooling circuit of a fuel cell.

According to an embodiment of the ion exchanger filter assembly, the at least two ion exchanger units may be filled with different ion exchanger materials. In this way, a suitable mixture of ion exchanger materials may be adjusted for a desired ion exchanger effect.

According to a further aspect of the invention, a connection pipe is proposed for an ion exchanger filter assembly, including a length extension and including along the length extension at least two connection openings for a fluid connection to an inlet socket or an outlet socket of an ion exchanger unit.

The connection pipes are designed such that they fit already existing inlet sockets and outlet sockets of the individual ion exchanger units of the ion exchanger filter assembly and seal them. The connection pipes may be fastened, for example, by means of clamping elements such as metal springs which snap-fit to the sockets of the ion exchanger units. The connected connection pipes then include only one additional connection socket as an interface to the cooling circuit.

According to an embodiment of the connection pipe, the connection openings may include radially inwardly arranged seal elements for the respective ion exchanger units which are held by holding elements, for example plastic rings. In this context, the holding elements may be for example clipped into the connection openings or may be welded thereto. In this manner, the housings of the ion exchanger units may be connected reliably to the connection pipes.

According to an embodiment of the connection pipe, clamping elements, for example spring elements, for engagement in circumferentially extending grooves of the inlet sockets and the outlet sockets of the ion exchanger units may be arranged in at least partially circumferentially extending slots of the connection openings. In this way, the connection between the connection pipe and the ion exchanger unit may be secured in a simple manner.

According to an embodiment, the connection pipe may include a closed end and an outlet connector, respectively. As an alternative, the connection pipe may include an inlet connector and an outlet connector, wherein the outlet connector is designed to be connected in fluid communication to an inlet connector of an adjoining connection pipe. The inlet-side fluid connection and the outlet-side fluid connection may be realized in this way by one connection pipe, respectively, or, as an alternative, it is however also possible to realize the fluid connections of a plurality of connection pipes which are arranged sequentially and connected to each other in fluid communication.

According to an embodiment of the connection pipe, the outlet connector may include a radially outwardly arranged coupling sleeve for fixation to the external connection conduit. In this way, the entire ion exchanger filter assembly may be connected in a simple and reliable manner to a cooling circuit of a fuel cell.

### BRIEF DESCRIPTION OF DRAWINGS

Further features and advantages are made apparent from the following drawings description. In the drawings, embodiments of the invention are illustrated. The drawings and this description contain numerous features in combination. A person of skill in the art will expediently consider the features also individually and combine them differently to expedient further combinations.

FIG. 1 shows an isometric illustration of an ion exchanger filter assembly to be flowed through by a fluid to be filtered, for example for a fuel cell system, according to an embodiment of the invention.

FIG. 2 shows a plan view of the ion exchanger filter assembly according to FIG. 1.

FIG. 3 shows an exploded illustration of the ion exchanger filter assembly according to FIG. 1.

FIG. 4 shows an isometric illustration of a connection pipe of the ion exchanger filter assembly according to FIG. 1.

FIG. 5 shows a longitudinal section of the connection pipe according to FIG. 4.

FIG. 6 shows an exploded illustration of the connection pipe according to FIG. 4.

### DETAILED DESCRIPTION

In the drawing figures, same or same-type components are identified with same reference characters. The drawing figures show only examples and are not to be understood as limiting.

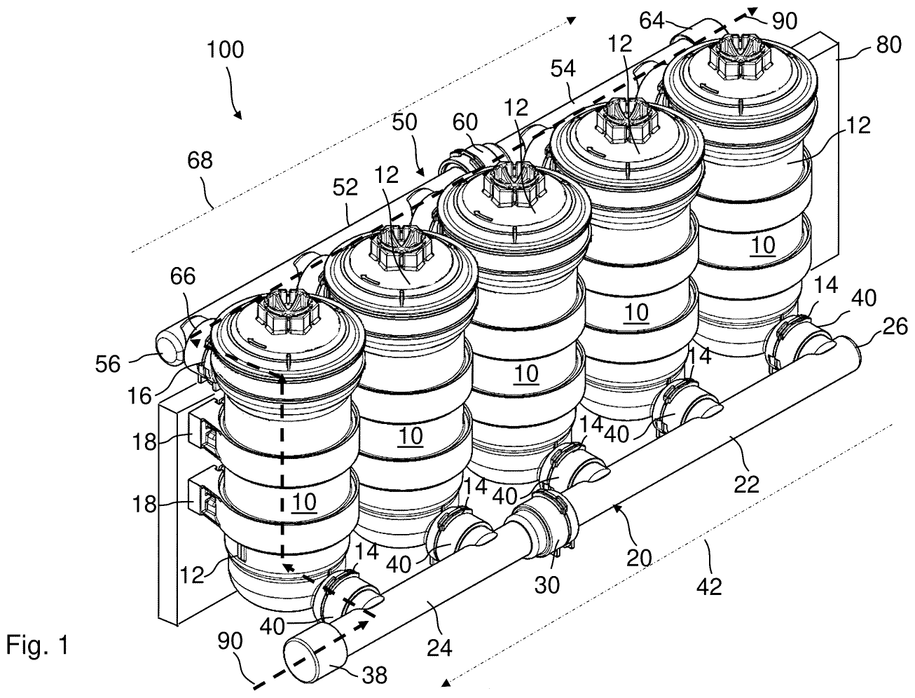

For explaining the invention, FIG. 1 shows an isometric illustration of the ion exchanger filter assembly 100 to be flowed through by a liquid to be filtered, for example for a fuel cell system, according to an embodiment of the invention. The liquid to be filtered may be, for example, a cooling liquid, i.e., water, of a cooling circuit of the fuel cell system.

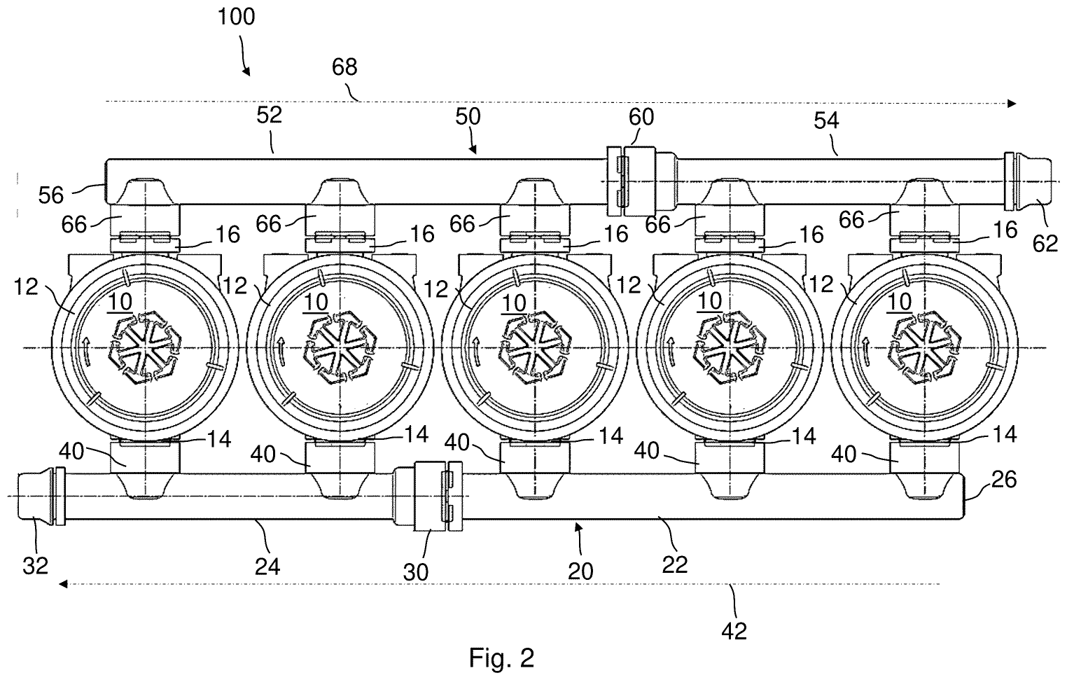

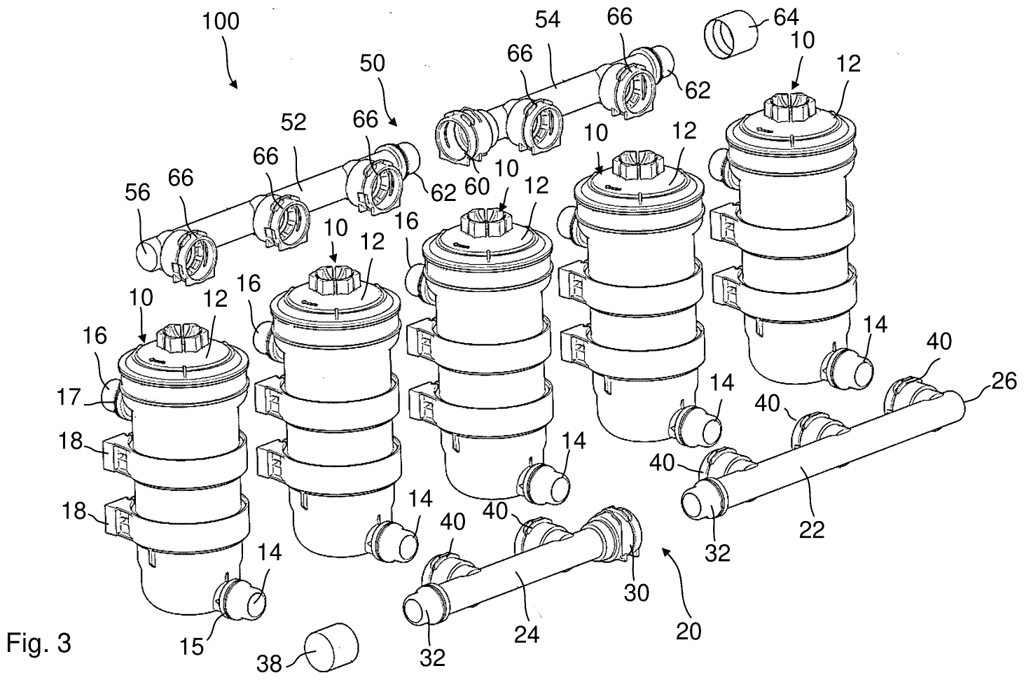

FIG. 2 shows a plan view of the ion exchanger filter assembly 100 while in FIG. 3 an exploded illustration of the ion exchanger filter assembly 100 is illustrated.

The ion exchanger filter assembly 100 comprises in this example five ion exchanger units 10 which comprise identical housings 12 with an inlet socket 14 and an outlet socket 16, respectively. Furthermore, the ion exchanger filter assembly 100 comprises an inlet-side fluid connection 20 and an outlet-side fluid connection 50 which connect the ion exchanger units 10 in fluid communication to each other. The inlet sockets 14 of the ion exchanger units 10 are connected in fluid communication to the inlet-side fluid connection 20 and the outlet sockets 16 to the outlet-side fluid connection 50.

The ion exchanger units 10 are arranged to be flowed through in parallel. In this context, the flow paths 90 each comprise a section through the inlet-side fluid connection 20, a section through the respective ion exchanger unit 10, and a section through the outlet-side fluid connection 50. In FIG. 1, as an example, one of the flow paths 90 through one of the ion exchanger units 10 is illustrated by a dashed line.

The flow paths 90 through the various ion exchanger units 10 are designed to be flowed through uniformly, respectively. In this context, all flow paths 90 have the same length. In this way, it is ensured that the two fluid connections 20, 50 and the ion exchanger units 10 are flowed through uniformly.

In an alternative embodiment, not illustrated, it may be provided that the flow paths 90 each comprise the same flow resistance. The respective flow path 90 through the fluid connections 20, 50 and the respective ion exchanger unit 10 may be adjusted, for example, by restriction plates in such a way that the respective flow path 90 through the individual ion exchanger units 10 has the same flow resistance so that the ion exchanger units 10 may be flowed through uniformly.

The inlet-side fluid connection 20 and the outlet-side fluid connection 50 comprise two connection pipes 22, 24, 52, 54, respectively. In this context, an inlet-side connection pipe 22 and an outlet-side connection pipe 52 comprise a closed end 26, 56 and an outlet connector 32, 62, respectively. Furthermore, an inlet-side connection pipe 24 and an outlet-side connection pipe 54 are present which comprise an inlet connector 30, 60 and an outlet connector 32, 62. In this context, the outlet connector 32, 62 of one of the connection pipes 22, 52 is connected in fluid communication to the inlet connector 30, 60 of the adjoining one of the connection pipes 24, 54, respectively.

Along their length extension 42, 68, the connection pipes 22, 24, 52, 54 each comprise at least one connection opening 40, 66 per ion exchanger unit 10. In this context, the inlet sockets 14 of the ion exchanger units 10 are connected in fluid communication to the connection openings 40 of the connection pipes 22, 24 and the outlet sockets 16 of the ion exchanger units 10 are connected in fluid communication to the connection openings 66 of the other connection pipes 52, 54.

In the connection openings 40, 66 of the connection pipes 22, 24, 52, 54, radially inwardly arranged seal elements 70 are arranged which are held by holding elements 72, for example plastic rings. The holding elements 72 may be clipped into the connection openings 40, 66, for example, or may be welded thereto.

The inlet sockets 14 and the outlet socket 16 of the housings 12 may be held by means of clamping elements 74, for example spring elements, which engage, through at least partially circumferentially extending slots 76 of the connection openings 40, 66, circumferentially extending grooves 15, 17 of the inlet sockets 14 and the outlet sockets 16.

As may be seen in FIG. 1, the housings 12 of the ion exchanger units 10 may be arranged on a common support plate 80 by means of holders 18, for example holders 18 circumferentially extending around the housings 12. In this context, the support plate 80 may be designed for providing a tolerance compensation for mounting of the housings 12, for example, in that the support plate 80 comprises slotted holes for attachment of the holders 18 with tolerance compensation.

The connection pipes 22, 24, 52, 54 each comprise outlet connectors 32, 62 for connecting to an external connection conduit, for example, of the cooling circuit of the fuel cell system. In this context, the outlet connectors 32, 62 of the connection pipes 22, 24, 52, 54 may expediently comprise radially outwardly arranged coupling sleeves 38, 64 for fixation to an external connection line.

The individual ion exchanger units 10 may be filled with different ion exchanger materials. In this way, a suitable mixture of ion exchanger materials may be adjusted for a desired ion exchanger effect.

The connection pipes 22, 24, 52, 54 of the inlet-side fluid connection 20 and of the outlet-side fluid connection 50 of the embodiment in FIGS. 1 to 3 are designed mirror-symmetrically, which is apparent only in regard to the arrangement of the clamping element 74 for securing the connection between the connection openings 40, 66 of the connection pipes 22, 24, 52, 54 and the inlet sockets 14 or outlet sockets 16 of the ion exchanger units 10. Alternatively, the respective connection pipes 22, 24, 52, 54 may also be of the same configuration.

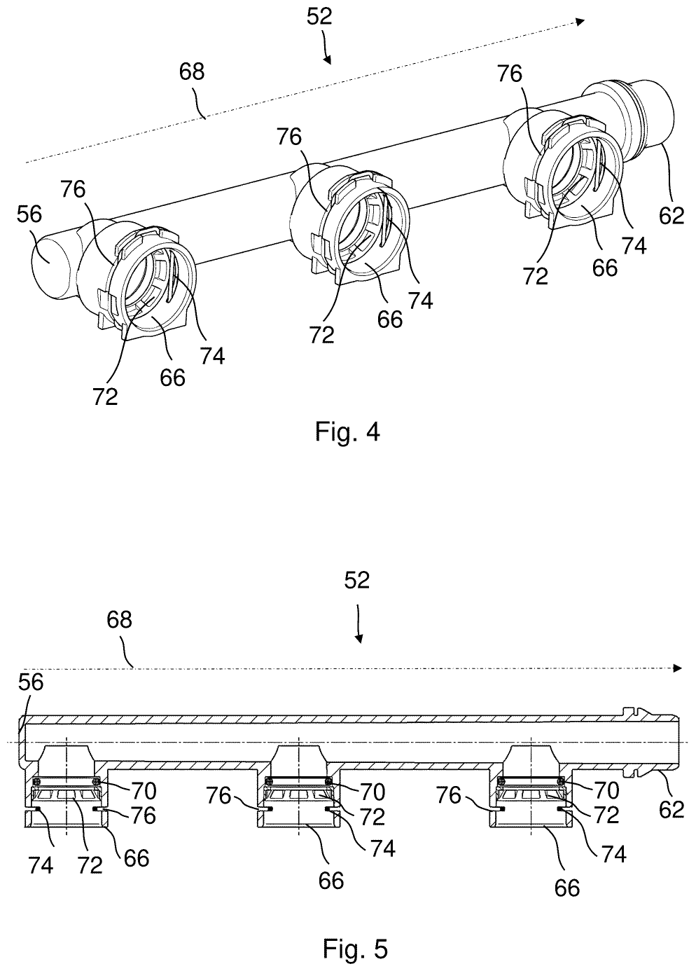

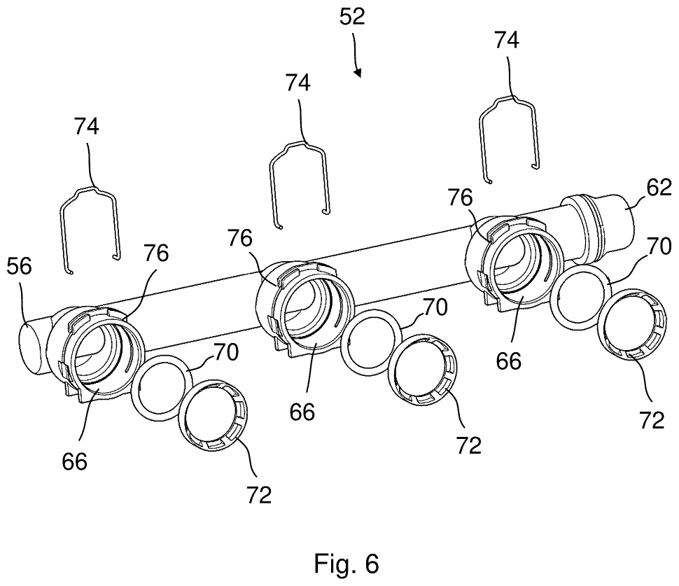

FIG. 4 shows an isometric illustration of a connection pipe 52 of the ion exchanger filter assembly 100 according to FIG. 1. In FIG. 5, for this purpose a longitudinal section of the connection pipe 52 is illustrated, while FIG. 6 shows an exploded illustration of the connection pipe 52.

The connection pipe 52 comprises a closed end 56 and an outlet connector 62, respectively. The outlet connector 62 is designed to be connected in fluid communication to an inlet connector 60 of an adjoining connection pipe 54.

Further, the outlet connector 62 may comprise a radially outwardly arranged coupling sleeve 64 for fixation to an external connection conduit.

The connection pipe 52 comprises a length extension 68 and comprises, along the length extension 68, three connection openings 66 for fluidic connection to the inlet socket 14 or outlet socket 16 of an ion exchanger unit 10.

The connection openings 66 for the respective ion exchanger units 10 comprise radially inwardly arranged seal elements 70 which are held by holding elements 72, for example plastic rings. The holding elements 72 may be clipped into the connection openings 66, for example, or may be welded thereto.

Clamping elements 74, for example spring elements, for engagement in circumferentially extending grooves 15, 17 of the inlet sockets 14 and of the outlet sockets 16 of the ion exchanger units 10 (see FIG. 3) are arranged in at least partially circumferentially extending slots 76 of the connection openings 40, 66.

### REFERENCE CHARACTERS

10 ion exchanger unit
12 housing
14 inlet socket
15 groove
16 outlet socket
17 groove
18 holder
20 fluid connection
22 connection pipe
24 connection pipe
26 closed end
30 inlet connector
32 outlet connector
38 coupling sleeve
40 connection opening
42 length extension
50 fluid connection
52 connection pipe
54 connection pipe
56 closed end
60 inlet connector
62 outlet connector
64 coupling sleeve
66 connection opening
68 length extension
70 seal element
72 holding element
74 clamping element
76 slot
80 support plate
90 flow path
100 ion exchanger filter assembly

What is claimed is:

1. An ion exchanger filter assembly to be flowed through by a liquid to be filtered, the ion exchanger filter assembly comprising:
at least two ion exchanger units, each comprising a housing comprising an inlet socket and an outlet socket;
an inlet-side fluid connection and an outlet-side fluid connection which connect in fluid communication the at least two ion exchanger units to each other;
wherein the inlet sockets of the at least two ion exchanger units are connected in fluid communication to the inlet-side fluid connection;
wherein the outlet sockets of the at least two ion exchanger units are connected in fluid communication to the outlet-side fluid connection;
wherein the at least two ion exchanger units are arranged so as to be flowed through in parallel along a respective flow path;
wherein the flow paths each comprise a section through the inlet-side fluid connection, a section through the respective ion exchanger unit, and a section through the outlet-side fluid connection;
wherein the flow paths each are designed to be flowed through uniformly, wherein either all of the flow paths have a same length or all of the flow paths have a same flow resistance.

2. The ion exchanger filter assembly according to claim 1, wherein the inlet-side fluid connection comprises at least one inlet-side connection pipe and the outlet-side fluid connection comprises at least one outlet-side connection pipe, wherein the at least one inlet-side connection pipe comprises at least two inlet-side connection openings along a length extension thereof and wherein the at least one outlet-side connection pipe comprises at least two outlet-side connection openings along a length extension thereof, wherein the inlet sockets of the at least two ion exchanger units are connected in fluid communication to the at least two inlet-side connection openings and the outlet sockets of the at least two ion exchanger units are connected in fluid communication to the at least two outlet-side connection openings.

3. The ion exchanger filter assembly according to claim 2, wherein the at least two inlet-side connection openings and the at least two outlet-side connection openings each comprise a radially inwardly arranged seal element which is held by a holding element, respectively.

4. The ion exchanger filter assembly according to claim 2, wherein the inlet sockets and the outlet sockets of the housings each comprise a circumferentially extending groove, wherein the at least two inlet-side connection openings and the at least two outlet-side connection openings each comprise an at least partially circumferentially extending slot, wherein the inlet sockets and the outlet sockets of the housings are held by a clamping element, respectively, the clamping element engaging, through the at least partially circumferentially extending slot, the circumferentially extending groove.

5. The ion exchanger filter assembly according to claim 2, wherein the at least one inlet-side connection pipe and the at least one outlet-side connection pipe each comprise a closed end and an outlet connector.

6. The ion exchanger filter assembly according to claim 2, wherein the at least one inlet-side connection pipe comprises an inlet connector and an outlet connector and/or the at least one outlet-side connection pipe comprises an inlet connector and an outlet connector.

7. The ion exchanger filter assembly according to claim 6, wherein two of the at least one inlet-side connection pipes are present, and wherein the outlet connector of one of the two inlet-side connection pipes is connected in fluid communication to the inlet connector of the other one of the two inlet-side connection pipes; and/or wherein two of the at least one outlet-side connection pipes are present, and wherein the outlet connector of one of the two outlet-side connection pipes is connected in fluid communication to the inlet connector of the other one of the two outlet-side connection pipes.

8. The ion exchanger filter assembly according to claim 2, wherein the housings of the at least two ion exchanger units are arranged on a common support plate and secured by holders.

9. The ion exchanger filter assembly according to claim 8, wherein the holders extend circumferentially around the housings.

10. The ion exchanger filter assembly according to claim 8, wherein the common support plate is configured to compensate tolerances when mounting the housings on the common support plate.

11. The ion exchanger filter assembly according to claim 10, wherein the common support plate comprises slotted holes for compensating tolerances.

12. The ion exchanger filter assembly according to claim 2, wherein the at least one inlet-side connection pipe and/or the at least one outlet-side connection pipe comprises an outlet connector, wherein the outlet connector comprises a radially outwardly oriented coupling sleeve for fixation to an external connection conduit.

13. The ion exchanger filter assembly according to claim 1, wherein the at least two ion exchanger units are filled with different ion exchanger materials, respectively.

14. A connection pipe for an ion exchanger filter assembly according to claim 1, the connection pipe comprising a length extension and further comprising, along the length extension, at least two connection openings for a fluid connection to the inlet sockets or the outlet sockets of the at least two ion exchanger units.

15. The connection pipe according to claim 14, wherein the at least two connection openings comprise radially inwardly arranged seal elements for the at least two ion exchanger units, wherein the seal elements are held by holding elements in the at least two connection openings.

16. The connection pipe according to claim 14, wherein the at least two connection openings each comprise an at least partially circumferentially extending slot, wherein the connection pipe further comprises clamping elements configured to engage circumferentially extending grooves of the inlet sockets or of the outlet sockets of the at least two ion exchanger units, wherein the clamping elements are arranged in the at least partially circumferentially extending slots of the at least two connection openings.

17. The connection pipe according to claim 14, comprising a closed end and an outlet connector.

18. The connection pipe according to claim 17, wherein the outlet connector comprises a radially outwardly arranged coupling sleeve for fixation to an external connection conduit.

19. The connection pipe according to claim 14, comprising an inlet connector and an outlet connector, wherein the outlet connector is configured to be connected in fluid communication to an inlet connector of another connection pipe.

20. The connection pipe according to claim 19, wherein the outlet connector comprises a radially outwardly arranged coupling sleeve for fixation to an external connection conduit.
